(19) United States
(12) Patent Application Publication
(10) Pub. No.: US 2004/0156071 A1
(43) Pub. Date: Aug. 12, 2004

(54) Language preferences for printer status strings and configuration menus

(76) Inventors: Daniel Travis Lay, Horseshoe Bend, ID (US); Curtis Reese, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/361,125

(22) Filed: Feb. 6, 2003

(51) Int. Cl. G06F 3/12; G06F 11/30; G06F 17/20

(52) U.S. Cl. 358/1.15; 710/19; 704/8

(57) ABSTRACT

Methods and system configurations including varying combinations of a client computer, a printer, and a network server convey a user's language preference for printer status updates and printer configuration information to a printer. The printer is thus able to respond to status and configuration requests with strings that are arranged in the user's desired language. Printer status strings and configuration strings are therefore displayable in a variety of languages which provides significant benefits in multi-lingual office settings.

### TECHNICAL FIELD

The present disclosure generally relates to printing, and more particularly, to communicating language preferences to a printer so that printer status strings returned to a computer and printer configuration menus on the printer's front panel are displayed in a desired language.

### BACKGROUND

Businesses that maintain international offices throughout various parts of the world often staff such offices with employees who communicate in a variety of different languages. As a result, such offices derive significant benefit from computer systems and related peripheral devices that are able to accommodate the variety of different languages. Currently, many peripheral printing devices have the ability to produce documents in a variety of different languages.

However, in addition to producing documents in different languages, printing devices need to be able to communicate other important information in different languages. Such information includes printer status information sent to client computers and printer configuration information displayed in menus on a printer's front panel display screen. Printer status information includes information such as what input trays are available, what output devices are available, paper jam events, empty paper tray events, low toner level events, and so on. Printer configuration information displayed on a printer's front panel display screen can include the printer status information just mentioned, but can also include printer configuration information that can be manipulated in various menus such as paper handling menus, print quality menus, and printing menus. The various menus allow a user to manipulate configuration settings from the printer's front panel such as paper tray settings, manual feed settings, resolution settings, toner density settings and so on.

Currently, many printing devices have the ability to communicate printer status information strings to a client computer in a variety of different languages. Printer status information strings are typically displayable on a client computer screen through functionality of a printer driver executing on the client computer. Therefore, a user can review printer status information by accessing an appropriate function within most printer drivers. However, although many printing devices can communicate printer status information strings in a variety of different languages, they currently communicate such strings only in English. This is a result of the current lack of any mechanism for instructing such printing devices as to which language should be used when providing printer status information strings. Therefore, regardless of a particular printer's ability to provide printer status information strings to a client computer in a variety of different languages, such strings are provided only in English. In a multi-lingual office setting as described above, it is apparent that such functionality offering printer status information only in English is wasted, because many employees may not be able to benefit from it.

Furthermore, many printing devices have the ability to adjust front panel displays so that printer configuration menus can be displayed in a variety of different languages. Therefore, a printer user in a multi-lingual office environment is able to read and manipulate the front control panels of printers regardless of the language in which the user communicates. However, there are problems with adjusting the language settings on most front panel displays that often make such adjustments impractical or impossible for inexperienced users not familiar with making the adjustments. The biggest problem with adjusting the language settings on most front panel printer displays is the awkward and difficult methods required to make the language adjustments. Such methods typically include the need to enter in various keystrokes to adjust the display to a desired language, or the need to power down the printer and restart it while depressing various keys, after which a desired language can be selected from the front panel. Such methods usually render a printer's ability to provide different languages on the front panel display a moot point, because users are simply not savvy enough or not willing to perform the required methods to change the front panel display language.

Accordingly, the need exists for a way to provide user language preferences to printers that allows users to exploit the language capabilities already present in many printers.

### SUMMARY

Various system configurations and methods provide printers with user language preferences so that printer status strings displayed on client computers and printer configuration strings displayed on printer front panel screens appear in a user's desired localized language.

In a first embodiment, a client computer includes a printer status language preference module configured to communicate a user's language preference to a printer. The printer returns status information strings to the client computer for display in a language based on the user's language preference. In one instance, the language preference module executes in association with a printer driver. When the printer driver is initiated to configure a print job, a user can select a desired language in which printer status strings will be displayed through the printer driver's user interface. When the printer driver requests a printer status update, the request includes the language preference information, and the printer returns printer status strings in the desired language for display on the client computer.

In another instance of the first embodiment, the language preference module executes in association with a stand-alone printer monitor application. Stand-alone printer monitors are typically launched by the operating system when a computer is booted up, and they remain active in order to continually monitor printer status and provide status information to a user. Upon activation, the stand-alone printer monitor notifies a printer that it is ready to receive unsolicited printer status update strings. The language preference module associated with the stand-alone printer monitor is configured to permit a user to specify a preferred language for printer status strings and to provide language preference information within the notification being sent to the printer by the printer monitor. Thus, each time there is a change in the printer's status, the printer sends a printer status update string, or strings, to the client computer in a language corresponding to the language preference information. The stand-alone printer monitor executing on the client computer makes printer status update strings available to a user in the user's preferred language.

In another instance of the first embodiment, any application program generally configured to manipulate or create text and/or graphics on a computer screen and transfer them to a printer for rendering in hard copy form includes a language preference module associated with a printer monitor module. Thus, upon initiation of the application program, the printer monitor module is configured to notify a printer that it is ready to receive unsolicited printer status update strings. The language preference module permits a user to specify a preferred language for printer status strings and includes the language preference within the notification sent to the printer. The printer sends printer status update strings to the client computer for display by the printer monitor module in a language corresponding to the language preference information.

In a second embodiment, a printer includes a status update module that automatically accesses language preference information from domain profiles maintained on a network server. In one instance, printer driver requests for printer status updates include user identification. A status update module on the printer is configured to automatically access the user's domain profile and return printer status update strings according to a language preference attribute of the domain profile. In another instance, a notification from a stand-alone printer monitor includes user identification. Each time there is a change in the printer's status, the status update module on the printer automatically accesses the user's domain profile and returns printer status update strings according to the language preference attribute of the domain profile. In yet another instance, a notification from a printer monitor module within an application program includes user identification. Again, when there is a change in the printer's status, the printer accesses the user's domain profile and returns printer status update strings according to the language preference attribute of the domain profile.

In a third embodiment, a printer includes a language update module for a front panel display screen that automatically accesses language preference information from domain profiles maintained on a network server. A user operating a printer's front control panel is identified through an identification tool. Based on the user identification, the printer accesses language preference information from the user's domain profile and displays front panel status and configuration strings in the user's preferred language.

In a fourth embodiment, a printer includes a language update module for a front panel display screen in addition to onboard user profiles. Each user profile includes a user's language preference. A user operating a printer's front control panel is identified through an identification tool. Based on the user identification, the printer accesses language preference information from the user's profile and displays front panel status and configuration strings in the user's preferred language.

### BRIEF DESCRIPTION OF THE DRAWINGS

The same reference numbers are used throughout the drawings to reference like components and features.

FIG. 1 illustrates a system environment that is suitable for providing language preferences to printers for printer status update strings and printer configuration strings.

FIG. 2 is a block diagram illustrating in greater detail, a particular embodiment of a client computer and a printer as might be implemented in the system environment of FIG. 1.

FIG. 3 is a block diagram illustrating in greater detail, a particular embodiment of a client computer, a printer, and a network server as might be implemented in the system environment of FIG. 1.

FIG. 4 is a block diagram illustrating in greater detail, a particular embodiment of a printer and a network server as might be implemented in the system environment of FIG. 1.

FIG. 5 is a block diagram illustrating in greater detail, a particular embodiment of a printer as might be implemented in the system environment of FIG. 1.

FIG. 6 is a flow diagram illustrating an example method for providing a language preference to a printer in order to display printer status update strings on a client computer in a preferred language.

FIG. 7 is a flow diagram illustrating an additional example method for providing a language preference to a printer in order to display printer status update strings on a client computer in a preferred language.

FIG. 8 is a flow diagram illustrating an example method for providing a language preference to a printer in order to display printer status update strings and printer configuration strings on a printer front panel screen in a preferred language.

FIG. 9 is a flow diagram illustrating an additional example method for providing a language preference to a printer in order to display printer status update strings and printer configuration strings on a printer front panel screen in a preferred language.

### DETAILED DESCRIPTION

Methods and system configurations including varying combinations of a client computer, a printer, and a network server convey a user's language preference for printer status updates and printer configuration information to a printer. The printer is thus able to respond to status and configuration requests with strings that are arranged in the user's desired language. Printer status strings and configuration strings are therefore displayable in a variety of languages which provides significant benefits in multi-lingual office settings.

Exemplary System Environment for Providing Language Preferences to Printers for Printer Status and Configuration Strings

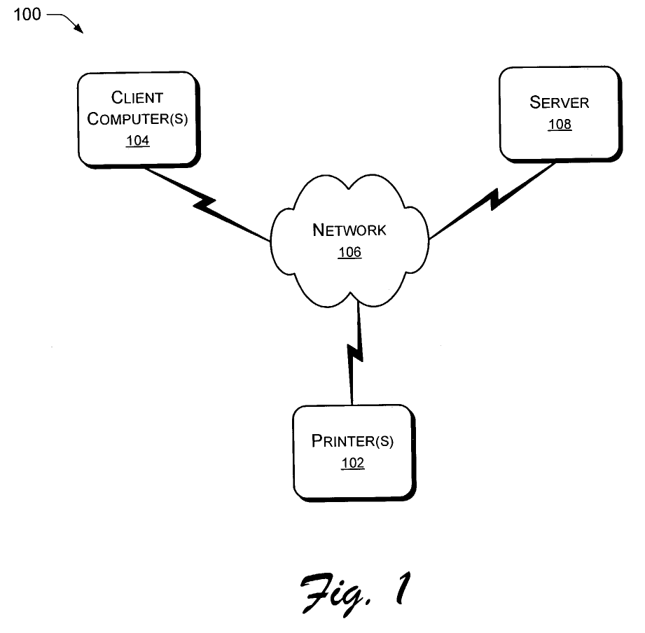

FIG. 1 illustrates an example of a system environment 100 suitable for providing printer(s) 102 with a language preference for returning printer status update strings and printer configuration strings. The exemplary system environment 100 of FIG. 1 includes printer(s) 102, client computer(s) 104, and server(s) 108 operatively coupled through a network connection 106. The network connection 106 can include both local and remote connections depending on the particular system configuration as discussed herein below in the various embodiments. Thus, network connection 106 may include, for example, a printer cable, a LAN (local area network), a WAN (wide area network), an intranet, the Internet, or any other suitable communication link.

This disclosure is applicable to various types of printer(s) 102 capable of rendering PDL (page description language) data in printed form on a print medium, such as printing pixels on paper. Therefore, printer(s) 102 can include devices such as laser-based printers, ink-based printers, dot matrix printers, dry medium printers, plotters and the like. In addition, printer(s) 102 might also include various multi-function peripheral (MFP) devices that combine a printing function with other functions such as facsimile transmission, scanning, copying and the like.

Client computer(s) 104 can be implemented as a variety of general purpose computing devices including, for example, a personal computer (PC), a laptop computer, a palmtop computer, a Macintosh, a workstation computer, and other devices configured to communicate with printer(s) 102. Client computer(s) 104 typically provides a user with the ability to manipulate or otherwise prepare in electronic form, an image or document to be rendered as an image that is printed or otherwise formed onto a print medium by printer(s) 102 after transmission over network 106. In general, client computer(s) 104 outputs client data to printer(s) 102 in a driver format (i.e., a page description language) suitable for the printer(s) 102, such as PCL or PostScript. Printer(s) 102 converts the client data and outputs it onto an appropriate recording media, such as paper or transparencies.

Server(s) 108 can also be implemented as a variety of general purpose computing devices such as a primary domain controller, a backup domain controller, a workstation computer or a Web server, or it might be implemented as a more specific server computer including, for example, a thin print server.

Exemplary System Embodiments for Providing Language Preferences to Printers for Returning Printer Status Strings to a Client Computer

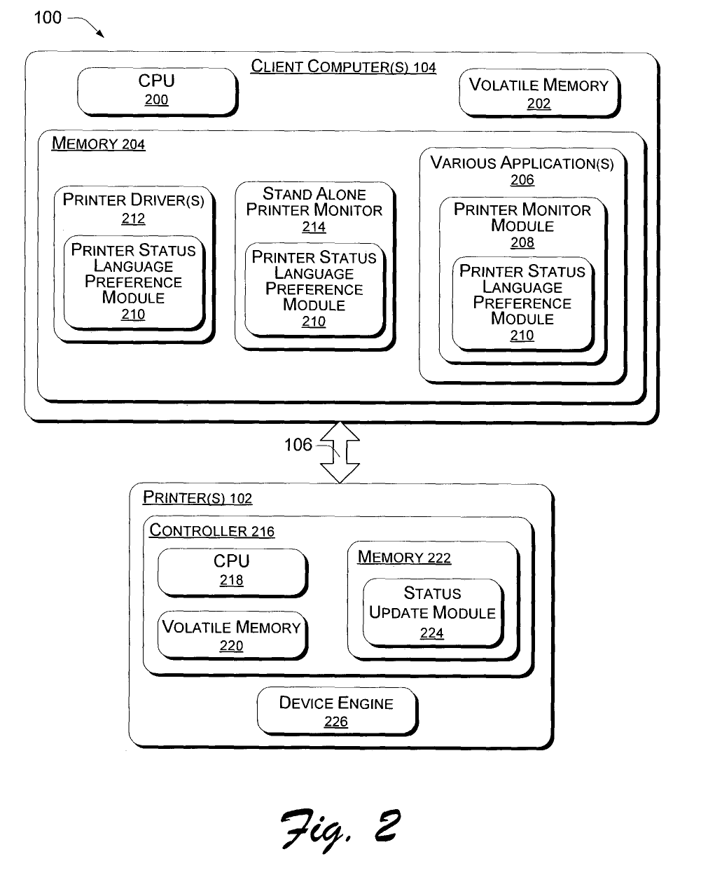

FIG. 2 is a block diagram illustrating an exemplary embodiment of a client computer 104 and a printer 102 as might be implemented in the system environment 100 of FIG. 1. Client computer 104 typically includes a processor 200, a volatile memory 202 (i.e., RAM), and a nonvolatile memory 204 (e.g., ROM, hard disk, floppy disk, CD-ROM, etc.). Nonvolatile memory 204 generally provides storage of computer/processor-readable instructions, data structures, program modules and other data for client computer 104. Client computer 104 may implement various application programs 206 stored in memory 204 and executed on processor 200 that create or otherwise form a document or image (e.g., text and graphics) on a computer screen that are transferable over network connection 106 to printer 102 for creating a hard copy of the document/image. Such applications 206 might include software programs implementing, for example, word processors, spread sheets, browsers, multimedia players, illustrators, computer-aided design tools and the like. The various applications 206 illustrated in the FIG. 2 embodiment include a printer monitor module 208 and associated printer status language preference module 210 generally configured to communicate a user's language preference to printer 102 as discussed more fully herein below.

Client computer 104 also implements one or more software-based device drivers such as printer driver 212 that are stored in nonvolatile memory 204 and executed on processor 200. Device drivers might also be implemented on the specific devices they are “driving” such as printer 102. Device drivers could also be implemented on remote print servers and content transformation servers that render print jobs for printers on the behalf of client computers 104. In general, printer driver 212 formats document information into a page description language (PDL) such as PostScript or Printer Control Language (PCL) or another appropriate format which is output to printer 102. In addition, printer driver 212 includes a printer status language preference module 210 generally configured to communicate a user's language preference to printer 102 as discussed more fully herein below.

Client computer 104 may also implement a stand-alone printer monitor application 214. Unlike the various application programs 206, stand-alone printer monitor 214 does not create or otherwise form a document or image transferable to printer 102 for creating a hard copy of the document/image. Rather, stand-alone printer monitor 214 is initiated by an operating system when client computer 104 is booted up and runs independently of other applications 206 or drivers 212 that may be running on client computer 104. Stand-alone printer monitor 214 generally runs in the background and remains active for the purpose of providing a user with printer status information. Like the various applications 206 and the printer driver 212 discussed above, stand-alone printer monitor 214 employs a printer status language preference module 210 generally configured to communicate a user's language preference to printer 102 as discussed more fully herein below.

Printer 102 includes controller 216 that, in general, processes data from client computer 104 to control the output of printer 102 through printer device engine 226. The controller 216 typically includes a data processing unit or CPU 218, a volatile memory 220 (i.e., RAM), and a nonvolatile memory 222. Nonvolatile memory 222 can include various computer storage media such as ROM, flash memory, a hard disk, a removable floppy disk, a removable optical disk and the like. Nonvolatile memory 218 generally provides storage of computer/processor-readable instructions, data structures, program modules and other data for printing device 102. Nonvolatile memory 218 includes status update module 224 which is generally configured to respond to requests for printer status information made by printer driver 212, the various application programs 206, or the stand-alone printer monitor 214 that execute on client computer 104.

As mentioned above, the printer status language preference module 210 associated with each of the printer driver 212, the various application programs 206, and the stand-alone printer monitor 214 on client computer 104 is generally configured to communicate a user's language preference to printer 102. In a first instance, the printer status language preference module 210 executes in association with printer driver 212. Printer driver 212 is typically initiated by a print command issued from within an application program 206. Upon initiation, printer driver 212 configures data from an application program 206 into a print job which is sent to printer 102 for rendering. In addition, printer driver 212 requests printer status updates so it can accurately reflect the current state of printer 102 to a user by displaying printer status strings and/or printer images on the computer 104 screen via the driver's 212 user interface.

In association with the printer status requests from printer driver 212, printer status language preference module 210 executes to provide a user's language preference information to printer 102. The language preference module 210 permits a user to adjust the language preference setting within the printer driver 212. The language preference information can be sent to printer 102 prior to, or as a part of, sending a print job to printer 102. Therefore, when the printer's 102 status update module 224 responds to the printer status request with status strings, it configures the status strings in the appropriate language as indicated by the user's language preference information. Thus, a user can access the printer driver's 212 user interface and review the current printer status in a language the user prefers.

In another instance of the first embodiment of FIG. 2, the printer status language preference module 210 executes in association with a stand-alone printer monitor application 214. Stand-alone printer monitor 214 is typically initiated by the operating system (not shown) executing on computer 104 when computer 104 is booted up, and it functions independently of other applications 206 or drivers 212 that may be running on computer 104. Stand-alone printer monitor 214 operates in the background to continually provide a user with printer status information. For example, the printer monitor 214 may display an icon in an icon tray at the bottom of the computer 104 screen that a user can click on to access the latest information about a particular printer's status.

Upon initiation, stand-alone printer monitor 214 notifies the status update module 224 on printer 102 that it is ready to receive status update information. In addition, the printer status language preference module 210 associated with the stand-alone printer monitor 214 executes to include a user's language preference information in the notification sent to printer 102. The language preference module 210 permits a user to adjust the language preference setting within the stand-alone printer monitor 214. Whenever the printer experiences a change in status, the printer's 102 status update module 224 responds by sending printer status update strings to the stand-alone printer monitor 214. The status strings are configured in the user's preferred language as indicated by the language preference information sent from the language preference module 210 associated with stand-alone printer monitor 214. Thus, a user can access the printer monitor's 214 user interface and review the current printer status in the language the user prefers.

In yet another instance of the first embodiment of FIG. 2, the printer status language preference module 210 executes in association with various applications 206 that are generally configured to manipulate or create text and/or graphics on client computer 104 and transfer them to printer 102 for rendering in a hard copy form. A printer monitor module 208 initiates when an application 206 is activated by a user. As with the stand-alone printer monitor 214 described above, printer monitor module 208 notifies the status update module 224 on printer 102 that it is ready to receive printer status update information. In addition, the printer status language preference module 210 associated with the printer monitor module 208 executes to include a user's language preference information in the notification sent to printer 102. The language preference module 210 permits a user to adjust the language preference setting within the printer monitor module 208. When the printer experiences a change in status, the printer's 102 status update module 224 responds by sending printer status update strings to the printer monitor module 208. The status strings are configured in the user's preferred language as indicated by the language preference information sent from the language preference module 210 associated with printer monitor module 208. Thus, a user can access and review the current printer status in the language the user prefers.

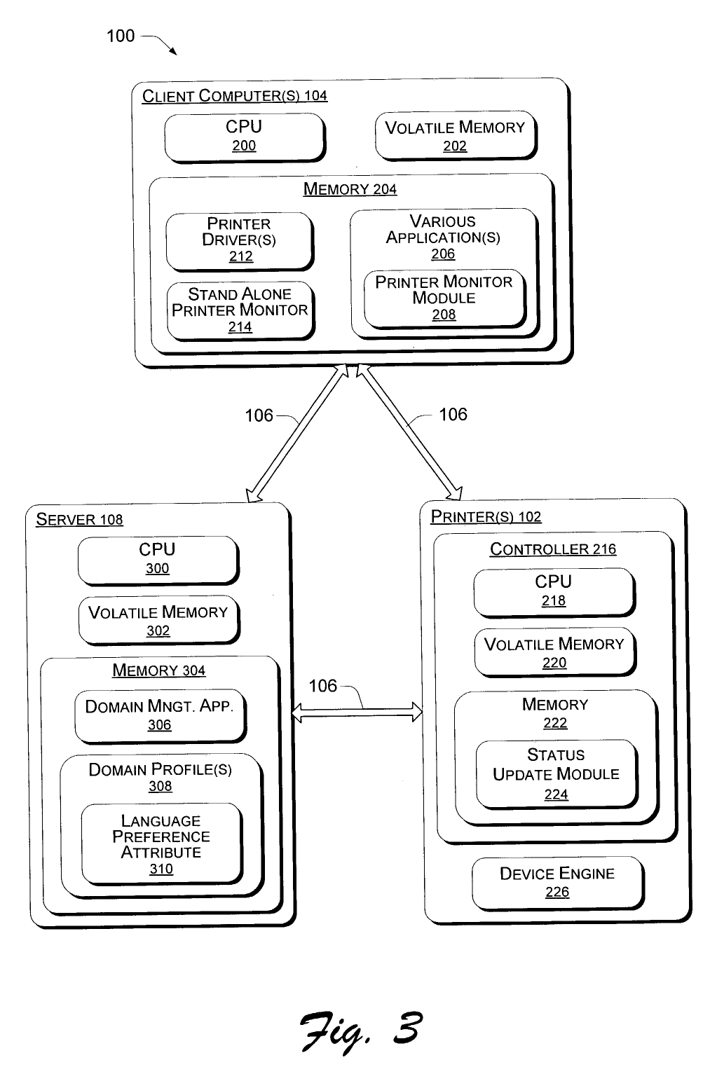

FIG. 3 is a block diagram illustrating an exemplary embodiment of a client computer 104, a printer 102, and a server 108 as might be implemented in the system environment 100 of FIG. 1. The client computer 104 is generally configured as described above with respect to the FIG. 2 embodiment, except that printer driver(s) 212, stand-alone printer monitor 214, and the printer monitor module 208 in the various applications 206 do not include a printer status language preference module 210. The printer(s) 102 in the FIG. 3 embodiment are also configured in a manner similar to the printer(s) 102 described above with respect to the FIG. 2 embodiment, except that the status update module 224 accesses language preference information in a different manner as discussed more fully herein below.

The server 108 of FIG. 3 is generally configured in a manner similar to that of client computer 104. Accordingly, server 108 typically includes processor(s) 300, a volatile memory 302 (i.e., RAM), and a nonvolatile memory 304 (e.g., ROM, hard disk, floppy disk, CD-ROM, etc.). Nonvolatile memory 304 generally provides storage of computer readable instructions, data structures, program modules and other data for server 108.

Domain management application 306 is stored on server 108 in memory 304 and executable on processor(s) 300 to generally manage network objects such as printer(s) 102 and client computer(s) 104. Individual network user accounts on network server 108 are also generally managed by domain management application 306 through user domain profile(s) 308.

In a first instance of the FIG. 3 embodiment, printer driver 212 requests printer status updates as in the previous embodiment in order to convey the current state of printer 102 to a user logged onto the system 100 through client computer 104. Printer driver 212 generally displays printer status strings and/or printer images via the driver's 212 user interface on the display screen of client computer 104. Printer driver 212 executing on computer 104 sends printer status requests to the status update module 224 on printer 102. Printer status update requests include a user identifier to identify the user and a client computer 104 identifier to identify the client computer 104 sending the request.

Upon receiving a printer status update request, status update module 224 on printer 102 accesses the appropriate user domain profile 308 corresponding to the user identifier within the request. The status update module 224 retrieves the language preference attribute 310 from the user domain profile 308 and configures printer status strings in the proper language according to the language preference attribute 310. The printer status strings are then sent to client computer 104 where printer driver 212 displays them in the user's preferred language through the driver's user interface via a computer display screen.

In another instance of the FIG. 3 embodiment, when a user boots up client computer 104 and logs onto system 100, stand-alone printer monitor 214 notifies the status update module 224 on printer 102 that it is ready to receive status update information. The notification includes a user identifier to identify the user and a client computer 104 identifier to identify the client computer 104 sending the notification. Thereafter, each time the printer 102 experiences a change in status, the status update module 224 accesses the server 108 and locates the appropriate user domain profile 308 corresponding to the user identifier within the notification. The status update module 224 retrieves the language preference attribute 310 from the user domain profile 308 and configures printer status update strings in the proper language according to the language preference attribute 310. The printer status update strings are then sent to client computer 104 where stand-alone printer monitor 214 displays them in the user's preferred language.

In yet another instance of the FIG. 3 embodiment, various applications 206 include a printer monitor module 208. The various applications 206 are generally configured to manipulate or create text and/or graphics on client computer 104 and transfer them to printer 102 for rendering in a hard copy form. When a user activates one of the various applications 206, a printer monitor module 208 notifies the status update module 224 on printer 102 that it is ready to receive printer status update information. The notification includes a user identifier to identify the user and a client computer 104 identifier to identify the client computer 104 sending the notification. Thereafter, each time the printer 102 experiences a change in status, the status update module 224 accesses the server 108 and locates the appropriate user domain profile 308 corresponding to the user identifier within the notification. The status update module 224 retrieves the language preference attribute 310 from the user domain profile 308 and configures printer status update strings in the proper language according to the language preference attribute 310. The printer status update strings are then sent to client computer 104 where the printer monitor module 208 associated with application 206 displays them in the user's preferred language.

The above-described instances of the FIG. 3 embodiment make it apparent that the embodiment permits a user to access the system 100 from any client computer 104 and still receive printer status information in the user's preferred language without having to alter a language preference setting within the client computer 104. The FIG. 3 embodiment contemplates a system administrator who enters each user's language preference attribute 310 upon setting up that user's domain profile 308 and network account. Once a user's domain profile 308 is properly configured, the status update module 224 on printer(s) 102 automatically determines the user's language preference for printer status strings from the user's domain profile 308, regardless of which computer 104 the user is logged into.

Exemplary System Embodiments for Providing Language Preferences to Printers for Returning Printer Status Strings And Configuration Strings to a Printer Front Panel Display

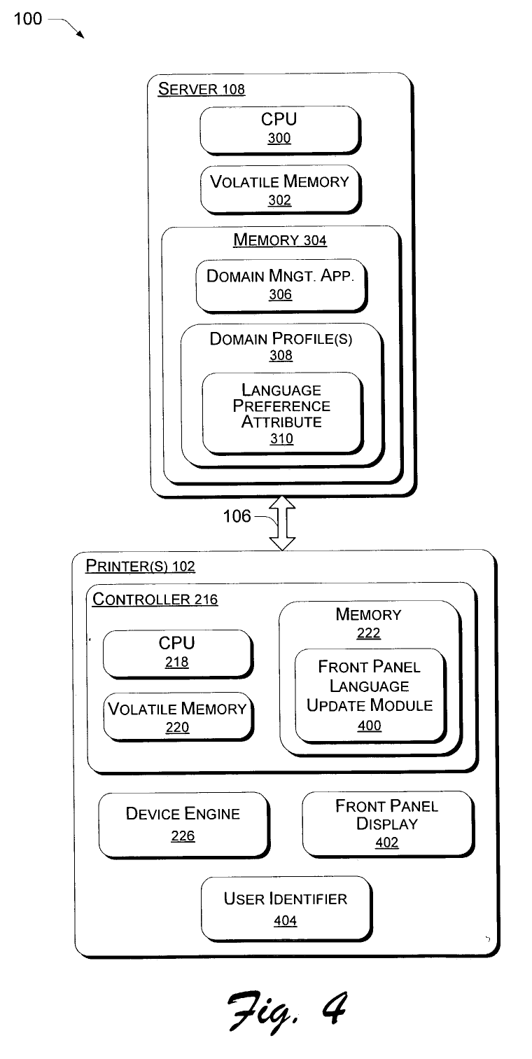

FIG. 4 is a block diagram illustrating an exemplary embodiment of a server 108 and printer(s) 102 as might be implemented in the system environment 100 of FIG. 1. The server 108 is configured as described above with respect to the FIG. 3 embodiment. The printer(s) 102 in the FIG. 4 embodiment is configured in a manner similar to the printer(s) 102 described above with respect to the FIG. 2 and FIG. 3 embodiments. However, the status update module 224 from the previous embodiments is replaced with a front panel language update module 400. In addition, printer(s) 102 of FIG. 4 include a front panel display 402 and a user identifier 404.

In the FIG. 4 embodiment, printer(s) 102 permit the adjustment or updating of the language used for displaying status strings and configuration strings on the front panel in the same general way that previously described embodiments display printer status update strings in a user's preferred language. That is, the status and configuration strings are displayed based on the identity of the user and language preference information associated with the user.

Printer(s) 102 of FIG. 4 permit users to review printer status information and/or manipulate the printer configuration via the front panel display 402 using a preferred language by entering their identity through user identifier 404. User identifier 404 can include a variety of conventional or emerging tools appropriate for verifying a user's identity. For example, user identifier 404 may include a bio-metric identifier such as a fingerprint scanner, a thumbprint scanner, or a retinal scanner. Such bio-metric identifiers may significantly reduce the time required for a user to enter an identification into printer(s) 102. However, user identifier 404 may also include a more conventional tool such as a simple keypad that permits the entry of a user identification number.

When a user identity is entered through user identifier 404, the front panel language update module 400 executes to access server 108 and locate the appropriate user domain profile 308 that corresponds with the user's identity. The language update module 400 retrieves the language preference attribute 310 from the user domain profile 308 and configures printer status strings and printer configuration menu strings in the proper language according to the language preference attribute 310. Thus, the front panel display 402 presents the status and configuration strings in the user's preferred language.

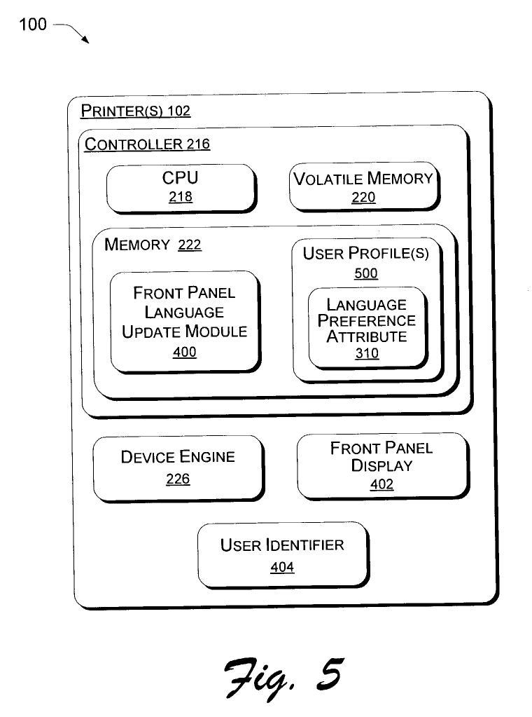

FIG. 5 is a block diagram illustrating an exemplary embodiment of a printer(s) 102 as might be implemented in the system environment 100 of FIG. 1. The printer(s) 102 in the FIG. 5 embodiment is configured in a manner similar to the printer(s) 102 described above with respect to the FIG. 4 embodiment. However, in addition to front panel language update module 400, memory 222 includes user profile(s) 500. User profile(s) 500 includes language preference attribute 310.

As in the embodiment of FIG. 4, the printer(s) 102 of the FIG. 5 embodiment permit users to review printer status information and/or manipulate the printer configuration via the front panel display 402 in a preferred language by entering their identity through user identifier 404. When a user identity is entered through user identifier 404, the front panel language update module 400 executes to access memory 222 and locate the appropriate user profile 500 that corresponds with the user's identity. The language update module 400 retrieves the language preference attribute 310 from the user profile 500 and configures printer status strings and printer configuration menu strings in the proper language according to the language preference attribute 310. Thus, the front panel display 402 presents the status and configuration strings in the user's preferred language.

Exemplary Methods for Providing Language Preferences to Printers for Printer Status and Configuration Strings

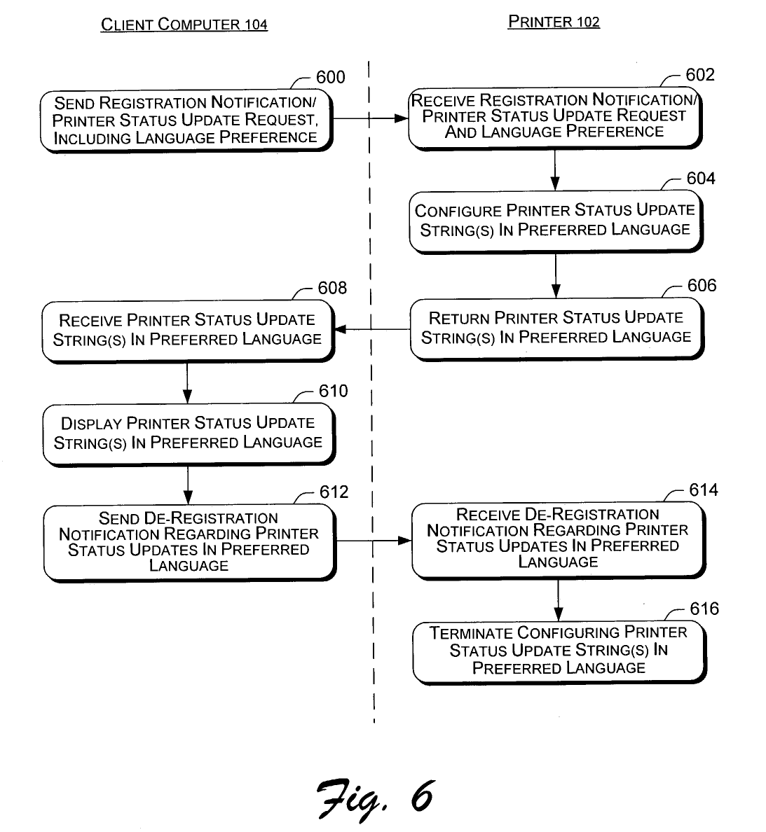

Example methods for providing language preferences to printers 102 for printer status strings and printer configuration strings will now be described with primary reference to the flow diagrams of FIGS. 6 through 9. The methods apply generally to the exemplary embodiments discussed above with respect to FIGS. 1 through 5. The elements of the described methods may be performed by any appropriate means, such as by the execution of processor-readable instructions defined on processor-readable media, such as a disk, a ROM or other such memory device.

Referring to the method illustrated in FIG. 6, at block 600, a notification or printer status update request is sent from a client computer 104 to printer 102. The notification or request includes a user language preference for printer status update strings. A notification is generally sent by a printer monitor application such as a stand-alone printer monitor 214 or by a printer monitor module 208 within an application 206 of FIG. 2, while a printer status update request is generally sent by a printer driver 212. A notification is usually a type of registration notification that informs a printer 102 that a printer monitor is ready to accept unsolicited printer status updates. The notification may also be a logon notification from a particular user on a client computer 104. At block 602, printer 102 receives the notification/request and user language preference. At block 604, printer 102 configures printer status update strings in the user's preferred language. At block 606, printer 102 sends the strings to the client computer 104.

At block 608, computer 104 receives the status strings, and at block 610, computer 104 displays the strings in the user's preferred language. At block 612, a de-registration notification is sent from client computer 104 to printer 102 via a stand-alone printer monitor 214, printer monitor module 208 within an application 206, or printer driver 212. The de-registration notification informs the printer 102 that the stand-alone printer monitor 214, printer monitor module 208 within an application 206, or printer driver 212 that initiated the de-registration notification no longer expects to receive printer status update strings in the previously expressed preferred language. The de-registration notification may also be a log-off notification intended to inform the printer 102 that a user is logging off and no longer desires to receive printer status update strings in the previously expressed preferred language. At block 614, printer 102 receives the de-registration notification, and at block 616, printer 102 terminates the configuring of printer status update strings in the previously instructed preferred language.

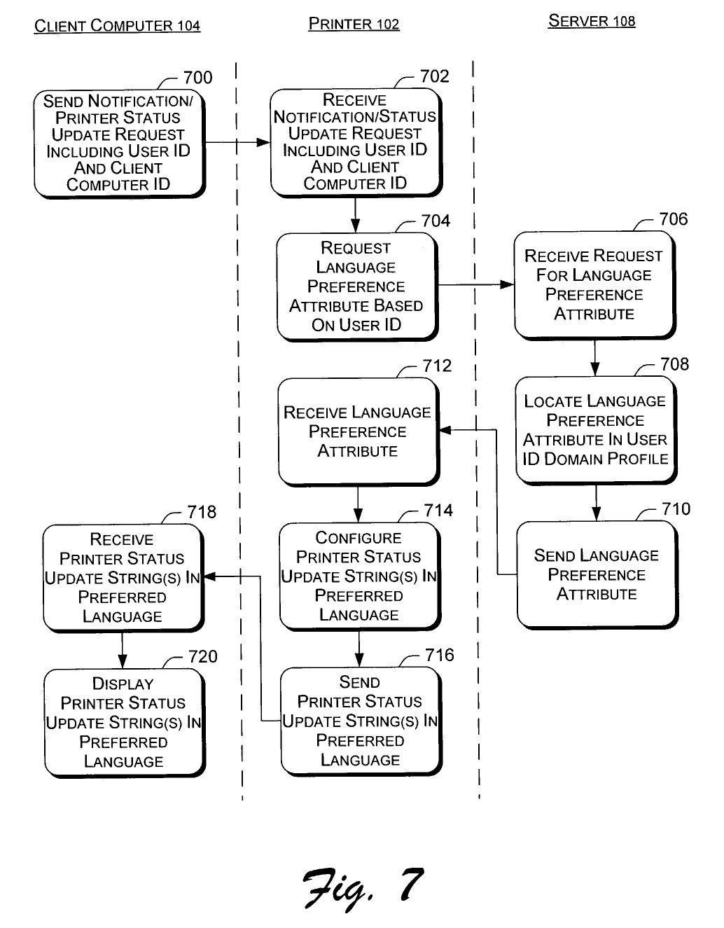

Referring now to the method illustrated in FIG. 7, at block 700, a notification or printer status update request is sent from a client computer 104 to printer 102. The notification or request includes a user ID (identification) and a client computer ID. Again, a notification is typically sent by a printer monitor application such as stand-alone printer monitor 214 or application 206 of FIG. 2, while a printer status update request is typically sent by a printer driver 212. A notification indicates to printer 102 that a printer monitor is ready to accept unsolicited printer status updates. At block 702, printer 102 receives the notification/request and user/client computer ID's. At block 704, printer 102 requests a language preference attribute from server 108 based on the user ID. At block 706, server 108 receives the request, and at block 708, locates the language preference attribute in a domain profile associated with the user ID. At block 710, server 108 sends the attribute to printer 102, which receives the attribute at block 712. At block 714, printer 102 configures printer status update strings in the user's preferred language, and at block 716, sends the strings to client computer 104. At block 718, client computer 104 receives the printer status, and at block 720, displays them in the user's preferred language.

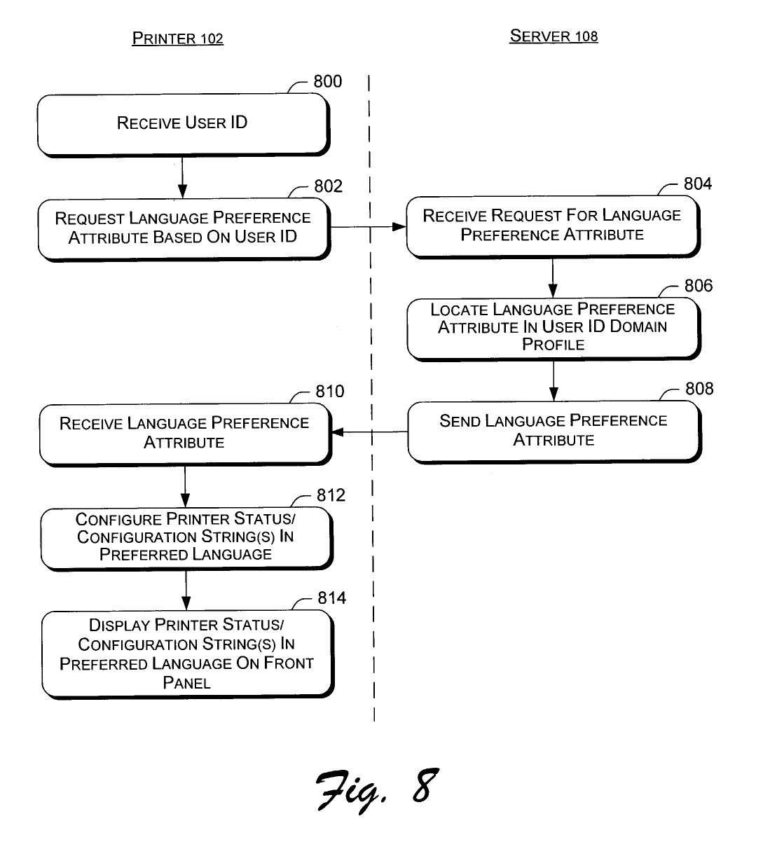

Referring now to the method illustrated in FIG. 8, at block 800, a printer 102 receives a user ID. The user ID is entered into the printer 102 via a user identifier 104. At block 802, the printer 102 requests a language preference attribute from server 108 based on the user ID. At block 804, server 108 receives the request, and at block 806, locates the language preference attribute in a domain profile associated with the user ID. At block 808, server 108 sends the language preference attribute to printer 102, which receives the attribute at block 810. At block 812, printer 102 configures printer status and/or configuration strings in the user's preferred language, and at block 814, displays the strings on the front panel display of the printer 102.

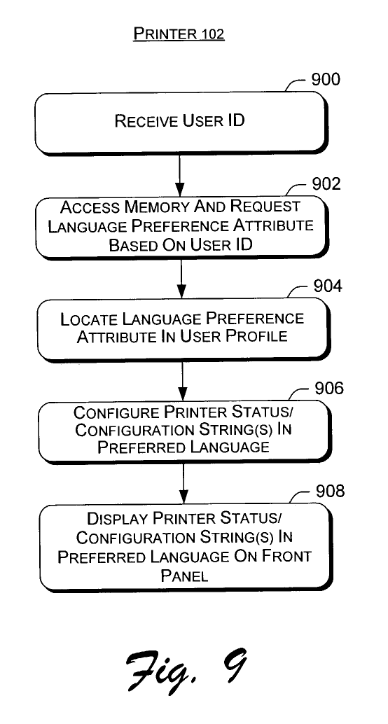

Referring now to the method illustrated in FIG. 9, at block 900, a printer 102 receives a user ID. The user ID is entered into the printer 102 via a user identifier 104. At block 902, the printer 102 accesses its memory and requests a language preference attribute based on the user ID. At block 904, the printer 102 locates the language preference attribute in a user profile associated with the user ID. At block 906, printer 102 configures printer status and/or configuration strings in the user's preferred language, and at block 908, displays the strings on the front panel display of the printer 102.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

Additionally, while one or more methods have been disclosed by means of flow diagrams and text associated with the blocks of the flow diagrams, it is to be understood that the blocks do not necessarily have to be performed in the order in which they were presented, and that an alternative order may result in similar advantages.

1. A processor-readable medium comprising processor-executable instructions configured for:
sending a request for a printer status update, the request including a language preference indicator; and
receiving printer status update strings in a language that corresponds to the language preference indicator.

2. A processor-readable medium as recited in claim 1, comprising further processor-executable instructions configured for displaying the printer status update strings in the particular language.

3. A processor-readable medium as recited in claim 1, wherein the sending and the receiving are performed by a printer monitor executing on a client computer.

4. A processor-readable medium as recited in claim 3, wherein the printer monitor is a printer monitor selected from a group of printer monitors comprising:
a stand-alone printer monitor application;
a printer monitor executing as part of another application program; and
a printer monitor executing as part of a printer driver.

5. A processor-readable medium comprising processor-executable instructions configured for:
sending a notification to a printer, the notification including a language preference indicator; and
each time a status change occurs in the printer, receiving printer status update strings in a language that corresponds to the language preference indicator.

6. A processor-readable medium comprising processor-executable instructions configured for:
receiving a request for printer status information, the request including preference information for a particular language; and
sending printer status information in the particular language.

7. A processor-readable medium as recited in claim 6, wherein the request is received from a printer monitor executing on a client computer.

8. A processor-readable medium as recited in claim 7, wherein the printer monitor is a printer monitor selected from a group of printer monitors comprising:
a stand-alone printer monitor application;
a printer monitor executing as part of another application program; and
a printer monitor executing as part of a printer driver.

9. A processor-readable medium comprising processor-executable instructions configured for:
receiving a notification from a printer monitor, the notification including preference information for a particular language; and
sending printer status information strings in the particular language.

10. A processor-readable medium comprising processor-executable instructions configured for:
sending a print job to a printer, the print job including a request for a printer status update in a particular language; and
receiving the printer status update as status strings configured in the particular language.

11. A processor-readable medium as recited in claim 10, comprising further processor-executable instructions configured for displaying the status strings in the particular language.

12. A processor-readable medium comprising processor-executable instructions configured for:
receiving a registration notification from a printer monitor running on a client computer, the registration notification including a language preference for printer status updates; and
whenever a status change occurs, automatically sending a printer status update to the printer monitor in a language that corresponds to the language preference.

13. A processor-readable medium as recited in claim 12, comprising further processor-executable instructions configured for:
receiving a de-registration notification from the printer monitor; and
terminating automatic sending of a printer status update to the printer monitor in a language that corresponds to the language preference.

14. A processor-readable medium as recited in claim 12, wherein the printer monitor is a printer monitor selected from the group of printer monitors comprising:
a stand-alone printer monitor application; and
a printer monitor module configured within an application program.

15. A processor-readable medium comprising processor-executable instructions configured for:
receiving a logon notification from a user at a client computer;
receiving a registration from a printer monitor running on the client computer, the registration including a language preference for printer status updates; and
whenever a status change occurs, automatically sending a printer status update to the printer monitor in a language that corresponds to the language preference.

16. A processor-readable medium as recited in claim 15, comprising further processor-executable instructions configured for:
receiving a logoff notification from the printer monitor; and
based on the logoff notification, terminating automatic sending of a printer status update to the printer monitor in a language that corresponds to the language preference.

17. A processor-readable medium comprising processor-executable instructions configured for:
receiving a logon notification from a client computer, the logon notification identifying a user;
receiving a printer status request from the client computer;
accessing language preference information from a domain profile on a server, the domain profile corresponding to the user; and
sending a printer status update to the client computer in a language that corresponds to the language preference information.

18. A processor-readable medium as recited in claim 17, comprising further processor-executable instructions configured for:
receiving a registration from a printer monitor application running on the client computer; and
whenever a status change occurs, automatically sending a printer status update to the printer monitor in a language that corresponds to the language preference information.

19. A processor-readable medium comprising processor-executable instructions configured for:
receiving a registration from a printer monitor running on a client computer, the registration including a user identification; and
whenever a printer status change occurs, accessing language preference information from a server-based domain profile that corresponds to the user identification and automatically sending a printer status update to the printer monitor in a language that corresponds to the language preference information.

20. A processor-readable medium as recited in claim 19, wherein the printer monitor is a printer monitor selected from a group of printer monitors comprising:
a stand-alone printer monitor application;
a printer monitor executing as part of another application program; and
a printer monitor executing as part of a printer driver.

21. A processor-readable medium comprising processor-executable instructions configured for:
receiving a user identification;
accessing a language preference attribute from a server-based domain profile that is associated with the user identification; and
displaying on a printer front panel display screen, a configuration menu in a language that corresponds to the language preference attribute.

22. A processor-readable medium as recited in claim 21, wherein the user identification is selected from a group of user identifications comprising:
a bio-metric identifier; and
a user identification number.

23. A processor-readable medium comprising processor-executable instructions configured for:
receiving a user identification;
accessing a language preference attribute from a user profile that is associated with the user identification and stored on a printer; and
displaying on a front panel display screen of the printer, a configuration menu in a language that corresponds to the language preference attribute.

24. A method of setting a language preference comprising:
sending a request for a printer status update, the request including a language preference indicator; and
receiving printer status update strings in a language that corresponds to the language preference indicator.

25. A method of setting a language preference comprising:
sending a notification to a printer, the notification including a language preference indicator; and
each time a status change occurs in the printer, receiving printer status update strings in a language that corresponds to the language preference indicator.

26. A method of setting a language preference comprising:
receiving a registration notification from a printer monitor running on a client computer, the registration notification including a language preference for printer status updates; and
whenever a status change occurs, automatically sending a printer status update to the printer monitor in a language that corresponds to the language preference.

27. A method as recited in claim 26, further comprising:
receiving a de-registration notification from the printer monitor; and
terminating the automatically sending a printer status update to the printer monitor in a language that corresponds to the language preference.

28. A method of setting a language preference comprising:
receiving a registration from a printer monitor running on a client computer, the registration including a user identification; and
whenever a printer status change occurs, accessing language preference information from a server-based domain profile that corresponds to the user identification and automatically sending a printer status update to the printer monitor in a language that corresponds to the language preference information.

29. A method of setting a language preference comprising:
receiving a user identification;
accessing a language preference attribute from a server-based domain profile that is associated with the user identification; and
displaying on a printer front panel display screen, a configuration menu in a language that corresponds to the language preference attribute.

30. A method of setting a language preference comprising:
receiving a user identification;
accessing a language preference attribute from a user profile that is associated with the user identification and stored on a printer; and
displaying on a front panel display screen of the printer, a configuration menu in a language that corresponds to the language preference attribute.

31. A computer comprising:
a printer driver configured to generate a print job for a printer; and
a printer status language preference module associated with the printer driver and configured for requesting, receiving, and displaying printer status update strings in a particular language.

32. A computer comprising:
a stand alone printer monitor configured to receive and display unsolicited printer status updates; and
a printer status language preference module associated with the stand alone printer monitor and configured for sending language preference information to a printer that indicates a particular language for the printer status updates.

33. A computer comprising:
an application program configured for creating a document capable of being rendered in hard-copy form by a printer;
a printer monitor module associated with the application program configured to receive and display printer status updates; and
a printer status language preference module associated with the printer monitor module configured for sending language preference information to a printer that indicates a particular language for the printer status updates.

34. A computer as recited in claim 33, wherein the application program is selected from a group of application programs comprising:
a word processor application program;
a spread sheet application program;
a browser application program;
a multimedia player application program;
an illustration application program; and
a computer-aided design application program.

35. A printer comprising:
a front panel display; and
a front panel language update module configured to receive a language preference attribute and display information on the front panel display in a preferred language based on the language preference attribute.

36. A printer as recited in claim 35, wherein the language preference module is received from a memory on the printer.

37. A printer as recited in claim 35, wherein the language preference module is received from a network server.

38. A server comprising:
a domain management application; and
a plurality of domain profiles, each domain profile having a language preference attribute, the domain management application configured to communicate the language preference attribute to a network printer.

39. A system comprising:
a server having a plurality of domain profiles, each domain profile having a language preference attribute; and
a printer configured to receive a language preference attribute from the server and to configure printer status updates and front panel menu information in a preferred language based on the language preference attribute.

40. A system as recited in claim 39, further comprising a client computer configured to identify a domain profile to the printer and to display printer status updates in the preferred language associated with language preference attribute from the domain profile.
